(19) United States
(12) Patent Application Publication
(10) Pub. No.: US 2005/0282060 A1
(43) Pub. Date: Dec. 22, 2005

(54) Fuel cell endplate system

(75) Inventors: Michael S. DeFillippis, Delmar, NY (US); Luke E. Yetto, Albany, NY (US); Keith G. Brown, Cliffton Park, NY (US)

Correspondence Address: HESLIN ROTHENBERG FARLEY & MESITI PC, 5 COLUMBIA CIRCLE, ALBANY, NY, 12203, US

(73) Assignee: MTI Micro Fuel Cells, Inc., Albany, NY (US)

(21) Appl. No.: 10/871,127

(22) Filed: Jun. 18, 2004

(51) Int. Cl. H01M 8/02

(52) U.S. Cl. 429/38; 429/39

(57) ABSTRACT

An endplate assembly is connected to a fuel cell stack. An endplate assembly has an external surface and an internal surface. The internal surface faces toward the fuel cell stack and the external surface is opposite the internal surface and faces away from the fuel cell stack. The endplate assembly includes at least one internal fluid flow passage located between the internal surface and the external surface. The at least one internal fluid flow passage is configured to direct fluid in a direction transverse to the direction faced by the internal surface and the direction faced by the external surface. Also, an interior portion may be located between the internal surface and the external surface. A port may provide fluid communication between an external component connected to the external surface and the interior portion. In addition, a component that processes, senses or measures a fluid may be integrated with said endplate assembly.

### CROSS-REFERENCE TO RELATED APPLICATIONS

This application is related to co-owned U.S. application Ser. No. ______, filed May 11, 2004 and entitled “Single Pump Fuel Cell System, the entire disclosure of which is incorporated herein by reference.

### FIELD OF THE INVENTION

This invention relates generally to fuel cell systems, and more particularly, to techniques for managing fluid flow throughout the fuel cell system.

### BACKGROUND INFORMATION

Fuel cells are devices in which electrochemical reactions are used to generate electricity from fuel and oxygen. A variety of materials may be suited for use as a fuel depending upon the materials chosen for the components of the cell. Organic materials in liquid form, such as methanol are attractive fuel choices due to the their high specific energy.

Fuel cell systems may be divided into “reformer-based” systems (i.e., those in which the fuel is processed in some fashion to extract hydrogen from the fuel before the hydrogen is introduced into the fuel cell system) or “direct oxidation” systems in which the fuel is fed directly into the cell without the need for separate internal or external fuel processing. Many currently available fuel cells are reformer-based. However, because fuel processing is complex and generally requires costly components which occupy significant volume, reformer based systems are more suitable for comparatively high power applications.

Direct oxidation fuel cell systems may be better suited for applications in smaller mobile devices (e.g., mobile phones, handheld and laptop computers), as well as for somewhat larger scale applications. In direct oxidation fuel cells of interest here, a carbonaceous liquid fuel (typically methanol or an aqueous methanol solution) is directly introduced to the anode face of a membrane electrode assembly (MEA).

One example of a direct oxidation fuel cell system is the direct methanol fuel cell or DMFC system. In a DMFC system, a mixture comprised of predominantly methanol or methanol and water is used as fuel (the “fuel mixture”), and oxygen, preferably from ambient air, is used as the oxidant. The fundamental reactions are the anodic oxidation of the fuel mixture into CO₂, protons, and electrons; and the cathodic combination of protons, electrons and oxygen into water. The overall reaction may be limited by the failure of either of these reactions to proceed to completion at an acceptable rate, as is discussed further hereinafter.

Typical DMFC systems include a fuel source or reservoir, fluid and effluent management systems, and air management systems, as well as the direct methanol fuel cell (“fuel cell”) itself. As used herein, the term “fuel cell system” shall include systems that include a single fuel cell, multiple fuel cells coupled in a fuel cell array, and/or a fuel cell stack. The fuel cell typically consists of a housing, hardware for current collection, fuel and air distribution, and a membrane electrode assembly (“MEA”) disposed within the housing.

The fuel cell system also typically includes an endplate assembly on each end of the fuel cell which has connections or ports connectable to conduits for receiving sources of air, fuel, water and any other materials needed to allow the fuel cell to function properly. Such ports may also be connected to each other via such external conduits. Further, such connections or ports may connect to conduits connected to valves, heat exchangers, and any other components desired to connect to the fuel cell. Such external connections may make a fuel cell system bulky, unnecessarily complex and difficult to integrate into an application device, or difficult to implement within the desired form factors.

The electricity generating reactions and the current collection in a direct oxidation fuel cell system take place at and within the MEA. In the fuel oxidation process at the anode, the fuel typically reacts with water and the products are protons, electrons and carbon dioxide. Protons from hydrogen in the fuel and in water molecules involved in the anodic reaction migrate through the proton conducting membrane electrolyte (“PCM”), which is non-conductive to the electrons. The electrons travel through an external circuit, which contains the load, and are united with the protons and oxygen molecules in the cathodic reaction. The electronic current through the load provides the electric power from the fuel cell. The invention set forth herein can also be implemented with any fuel cell system where water from the cathode is returned to the anode aspect of the fuel cell, including reformer-based systems as well as systems that use silicon components as a means of directing the flow of electrons.

A typical MEA includes an anode catalyst layer and a cathode catalyst layer sandwiching a centrally disposed PCM. One example of a commercially available PCM is NAFION® (NAFION® is a registered trademark of E.I. Dupont de Nemours and Company), a cation exchange membrane based on polyperflourosulfonic acid, in a variety of thicknesses and equivalent weights. The PCM is typically coated on each face with an electrocatalyst such as platinum, or platinum/ruthenium mixtures or alloy particles. A PCM that is optimal for fuel cell applications possesses good protonic conductivity, and may have to be properly hydrated to perform well. On either face of the catalyst coated PCM, the MEA further typically includes a “diffusion layer”. The diffusion layer on the anode side is employed to evenly distribute the liquid or gaseous fuel over the catalyzed anode face of the PCM, while allowing the reaction products, typically gaseous carbon dioxide, to move away from the anode face of the PCM. In the case of the cathode side, a diffusion layer is used to allow a sufficient supply of and a more uniform distribution of gaseous oxygen to the cathode face of the PCM, while minimizing or eliminating the accumulation of liquid, typically water, on the cathode aspect of the PCM. Each of the anode and cathode diffusion layers also assist in the collection and conduction of electric current from the catalyzed PCM to the current collector.

Direct oxidation fuel cell systems for portable electronic devices ideally are as small as possible for a given electrical power and energy requirement. The power output is governed by the rates of the reactions that occur at the anode and the cathode of the fuel cell operated at a given cell voltage. More specifically, the anode process in direct methanol fuel cells, which use acid electrolyte membranes including polyperflourosulfonic acid and other polymeric electrolytes, involves a reaction of one molecule of methanol with one molecule of water. In this process, water molecules are consumed to complete the oxidation of methanol to a final CO₂ product in a six-electron process, according to the following electrochemical equation:
CH₃OH+H₂O [symbol] CO₂+6H⁺+6H⁺6e⁻ (1)

Generally, in order to maintain process (1) during fuel cell operation, it is important that fluid flow throughout the fuel cell system is balanced correctly. More specifically, the delivery of fuel at the appropriate concentration is a consideration and varies with fuel cell operating conditions and ambient conditions. Secondly, water management may be an important consideration because water is a reactant in the anodic process at a molecular ratio of 1:1 (water:methanol), so that the supply of water, together with methanol to the anode at an appropriate weight (or volume) ratio may be critical for sustaining this process in the fuel cell system. In addition, water is generated at the cathode, and this cathode-generated water can be recirculated to the anode for use in the anodic portion of the process (1). The water also helps maintain adequate hydration of the membrane. However, too much water can lead to cathode flooding. Thus, it may be desirable to finely control the water balance throughout the fuel cell system using desired fluid management components.

The present invention is described in conjunction with a stack comprised of more than one fuel cell, and which typically include more than one bipolar plate. Such a stack can be used to meet required form factor and power requirements. However, those skilled in the art will recognize that the precise configuration of the fuel cells may comprise a single fuel cell, or a plurality of fuel cells arranged in a substantially planar system, while remaining within the scope of the present invention.

Some systems that have active water management techniques are based on feeding the cell anode with a very dilute methanol solution, pumping excess amounts of water at the cell cathode back to cell anode and dosing the recirculation liquid with neat methanol stored in a reservoir. Such active systems that include pumping can provide, in principle, maintenance of appropriate water level in the anode by dosing the methanol from a fuel source into a recirculation loop. The loop also receives water that is collected at the cathode and pumped back into the recirculation anode liquid. In this way, a desired water/methanol anode mix can be maintained. However, the multiple pumps that are needed to carry the various solutions throughout the fuel cell can lead to parasitic losses that ultimately result in a less efficiently operating fuel cell system. This has been particularly true in applications in which a fuel cell stack is employed.

Another challenge arises in a system containing a fuel cell stack when it is necessary to purge the stack of fluids. This procedure might be performed to change the fuel concentration if the concentration of the fuel in the stack is greater than or lower than a predetermined desired level. Other situations in which a stack purge is performed is when the system is to be shutdown for a routine maintenance check or for repairs, where the pressure within the fuel cell is greater than desired, or where it is desirable to put the fuel cell stack in a freeze tolerant state.

Temperature regulation is also a consideration in fuel cell system management. For example, fuel cell operating temperatures must be regulated so that the build up of excess heat is controlled. Sometimes excess heat must be dissipated. Ambient environmental conditions are a factor in the dissipation of heat, and affect fuel cell performance, particularly in sub-freezing ambient environments.

Based upon all of these considerations, there remains a need for controlling the flow of fluids and controlling temperature in a fuel cell system, and specifically, there is a need for a fuel cell system in which the flow of fuel, water, effluents and other gases can be finely controlled depending upon the desired operating characteristics of the fuel cell system or the ambient environmental conditions. There remains a further need for a system that incorporates this functionality, but is not bulky and which minimizes or eliminates the necessity of components of the fuel cell system using external conduits or hoses.

### SUMMARY OF THE INVENTION

The present invention provides, in a first aspect, an endplate assembly for a fuel cell system having a fuel cell stack. The assembly includes an internal surface and an external surface. The internal surface is configured to face toward the fuel cell stack and the external surface is opposite the internal surface and configured to face away from the fuel cell stack. One or more fluid flow pathways is located between the internal surface and the external surface. The one or more fluid flow pathways is configured to direct fluid in multiple directions through the endplate assembly.

The present invention provides, in a second aspect, a fuel cell system which includes a fuel cell stack connected to an endplate assembly. The endplate assembly has an external surface and an internal surface. The internal surface faces toward the fuel cell stack and the external surface is opposite the internal surface and faces away from the fuel cell stack. The endplate assembly includes one or more fluid flow pathways located between the internal surface and the external surface. The one or more fluid flow pathways is configured to direct fluid in multiple directions through the endplate assembly.

The present invention provides, in a third aspect, an endplate assembly for a fuel cell system having a fuel cell stack. The assembly includes an external surface, an internal surface, and an interior portion located between the internal surface and the external surface. The internal surface faces toward the fuel cell stack and the external surface is opposite the internal surface and faces away from the fuel cell stack, in response to the internal surface being engaged with the fuel cell stack. The external surface includes a port configured to allow an external fuel cell component to be mounted thereon to provide direct fluid communication between the interior portion and the external fuel cell component.

The present invention provides, in a fourth aspect, a fuel cell system which includes a fuel cell stack connected to an endplate assembly. The endplate assembly includes an internal surface and an external surface. The internal surface faces toward the fuel cell stack and the external surface is opposite the internal surface and faces away from the fuel cell stack. The external surface includes a port configured to directly connect to an external fuel cell component to provide direct fluid communication between the endplate assembly and the external fuel cell component.

The present invention provides, in a fifth aspect, an endplate assembly for a fuel cell system having a fuel cell stack which includes an internal surface and an external surface. The internal surface is configured to face toward the fuel cell stack and the external surface is opposite the internal surface and configured to face away from the fuel cell stack. A fluid processing component, a measuring component, and/or a sensing component are located between the internal surface and the external surface.

The present invention provides, in a sixth aspect, a fuel cell system which includes an endplate assembly connected to a fuel cell stack. The endplate assembly has an external surface and an internal surface. The internal surface faces toward the fuel cell stack and the external surface is opposite the internal surface and faces away from the fuel cell stack. The endplate assembly includes a fluid processing component, a measuring component, and/or a sensing component located between the internal surface and the external surface.

The aspects of the present invention described above provide for fluid flow within, and/or through, one or more endplate assemblies of a fuel cell system. The use of such pathways, passages and/or ports allows external fuel cell processing, sensing, measuring or supply components to be directly connected to an exterior surface of an endplate assembly. For example, the direct connection of such components to ports on the exterior surface of the endplate assembly may reduce or eliminate the need for external conduits or hoses to connect the endplate and fuel cell stack of the fuel cell assembly to such external components. Further, the routing of flow within the endplates may reduce or eliminate the need for hoses or conduits to route fluid from one portion of the endplate to another portion thereof. Moreover, such fuel cell processing, sensing, measuring or supply components may be located within an end plate assembly and may be connected to one another by internal passages thereby also reducing or eliminating the need for external hoses or conduits to route fluid from one component to another. Finally, the endplate assemblies of the present invention allow the endplates to be disposed on the opposite ends of the fuel cell stack to allow fluids from within the stack to directly enter the endplates without the need for hoses, or conduits or other external fluid connectors.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention will be apparent from the following detailed description of preferred embodiments taken in conjunction with the accompanying drawings in which:

FIG. 1 is a perspective view of a fuel cell system in accordance with the present invention, excluding external components thereof;

FIG. 2 is a perspective view of a cathode endplate assembly of the fuel cell system of FIG. 1;

FIG. 3 is an exploded view of the elements of the endplate assembly of FIG. 2;

FIG. 4 is a perspective view of an external side of an outer layer of the endplate assembly of FIG. 2;

FIG. 5 is a perspective view of a stack side of the outer layer of FIG. 4;

FIG. 6 is a perspective view of an outer side of an inner layer of the endplate assembly of FIG. 2;

FIG. 7 is a perspective view of a stack side of the inner layer of FIG. 6;

FIG. 8 is a perspective view of an anode endplate assembly of the fuel cell system of FIG. 1;

FIG. 9 is an exploded view of the anode endplate assembly of FIG. 8;

FIG. 10 is a perspective view of a stack side of an outer layer of the anode endplate assembly of FIG. 8;

FIG. 11 is a perspective view of an outer side of the outer layer of FIG. 10;

FIG. 12 is a perspective view of a stack side of a second anode endplate layer of the anode endplate assembly of FIG. 8;

FIG. 13 is a perspective view of an outer side of the second anode endplate layer of FIG. 12;

FIG. 14 is a perspective view of an outer side of a third anode layer of the endplate assembly of FIG. 8;

FIG. 15 is a perspective view of a stack side of the third anode endplate layer of FIG. 14;

FIG. 16 is a perspective view of an outer side of an inner layer of the anode endplate assembly of FIG. 8;

FIG. 17 is a perspective view of a stack side of the inner layer of FIG. 16;

FIG. 18 is an exploded view of the fuel cell system of FIG. 1;

FIG. 19 is a perspective view of a pump being connected to the outer side of the outer layer of the anode endplate assembly of FIGS. 8 and 9;

FIG. 20 is an exploded view of the pump and the outer layer of FIG. 19;

FIG. 21 is a schematic view of the fuel cell system of FIG. 1 further including components omitted therefrom in FIG. 1;

FIG. 22 is an elevational view of the external side of the cathode endplate assembly of FIGS. 2 and 3 with hidden features being shown in phantom;

FIG. 23 is an elevational view of the stack side of the cathode endplate assembly of FIGS. 2 and 3 with hidden features shown in phantom;

FIG. 24 is an elevational view of the stack side of the anode endplate assembly of FIGS. 8 and 9 with hidden features shown in phantom; and

FIG. 25 is an elevational view of the external side of the anode endplate assembly of FIGS. 8 and 9 with hidden features shown in phantom.

### DETAILED DESCRIPTION OF A PREFERRED EMBODIMENT

In accordance with the principles of the present invention, an endplate assembly for a fuel cell system having a fuel cell stack is provided. The endplate assembly may include an internal surface and an external surface. The internal surface may be configured to face toward the fuel cell stack, and the external surface is opposite the internal surface and may be configured to face away from the fuel cell stack. One or more fluid flow pathways is located between the internal surface and the external surface. The one or more fluid flow pathways is configured to direct fluid in multiple directions. Also, the external surface may include a port configured to directly connect to an external fuel cell component to provide direct fluid communication between the endplate assembly and the external fuel cell component. Fuel cell components may be located between the internal surface and the external surface.

Further, the external fuel cell components may be directly attached to ports and/or an exterior side of an endplate assembly thereby minimizing or eliminating external conduits or tubes connecting the endplate assembly to any such components. The minimization of such external conduits or tubes may make a fuel cell system more compact and thus more easily located and/or stored. Alternatively, such components may be integral to, or within, the endplate assembly. Further, such external fuel cell components may include components for supplying fluids to the fuel cell system, components for processing fluid for the fuel cell system and/or components for sensing or measuring fluid properties and/or other properties of the fuel cell system. Such internal or external components may include valves, pumps, heat exchangers, pressure sensors, concentration sensors, filters, gas and liquid separators, sources of fuel, temperature sensors, sources of water or sources of air, for example.

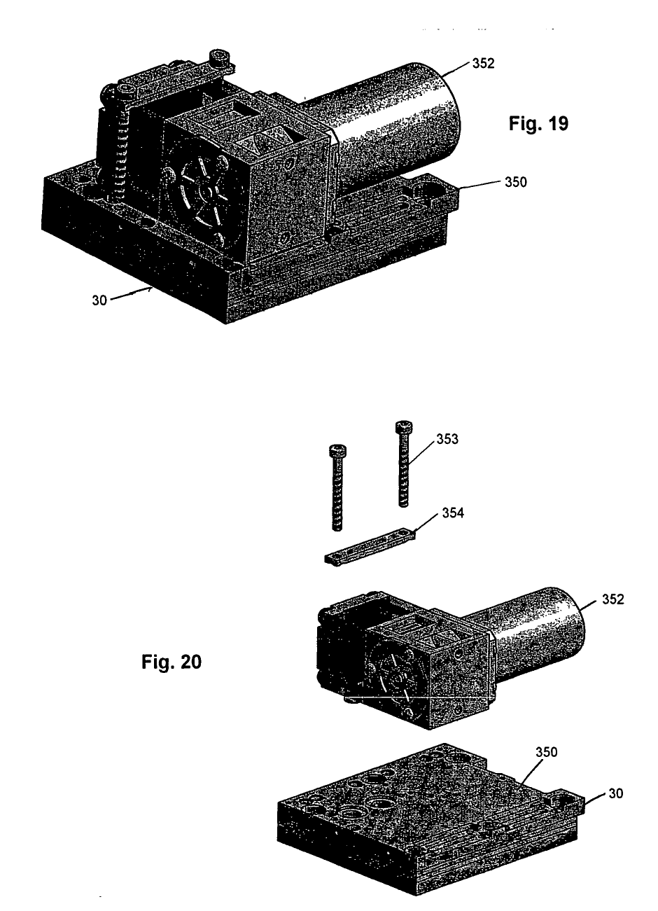

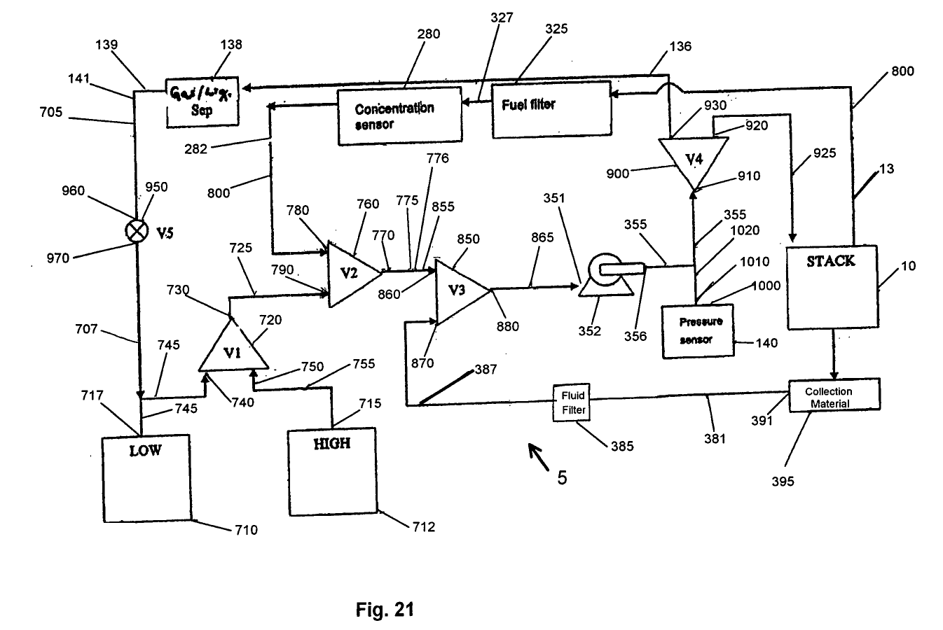

Components may be attached to the endplate assembly by any means suitable to one of skill in the art including bolts, screws, clamps or other suitable fastening means, as well as friction or pressure fits and bonding techniques. Alternatively, such components could be manufactured integrally with said endplates. Furthermore, such components may be sealed to the endplate assembly by any suitable sealing means known to those of the art including but not limited to gaskets, o-rings or the like. Endplate assemblies may be manufactured with ports having grooves or lips for mounting of gaskets or o-rings therein for sealing with the components. In one example, exterior side 350 is attached to a pump 352 for pumping fluid through fuel cell system 5 as depicted in FIGS. 19-20. Pump 352 may be bolted to exterior side 350 using bolts 353 and bracket 354, for example. Also, O rings, or other seals, may be utilized to prevent the leakage of any fluids which flow from anode endplate assembly 30 through pump 352 and return to anode endplate assembly 30, for example.

In an exemplary embodiment depicted in FIG. 1, a fuel cell system 5 includes a fuel cell stack 10 connected to a cathode endplate assembly 20 and an anode endplate assembly 30.

An endplate assembly typically contains one or more rigid layers. At each end of the fuel cell stack an endplate assembly functions to maintain a pressure on the stack. Thus, a cathode endplate maintains a force on the cathode side of the stack toward the anode while the anode endplate maintains a force on the anode side of the stack toward the cathode. The endplate assembly of the present invention is capable of transmitting a force toward the stack while allowing for the flow of fluid in various directions therethrough.

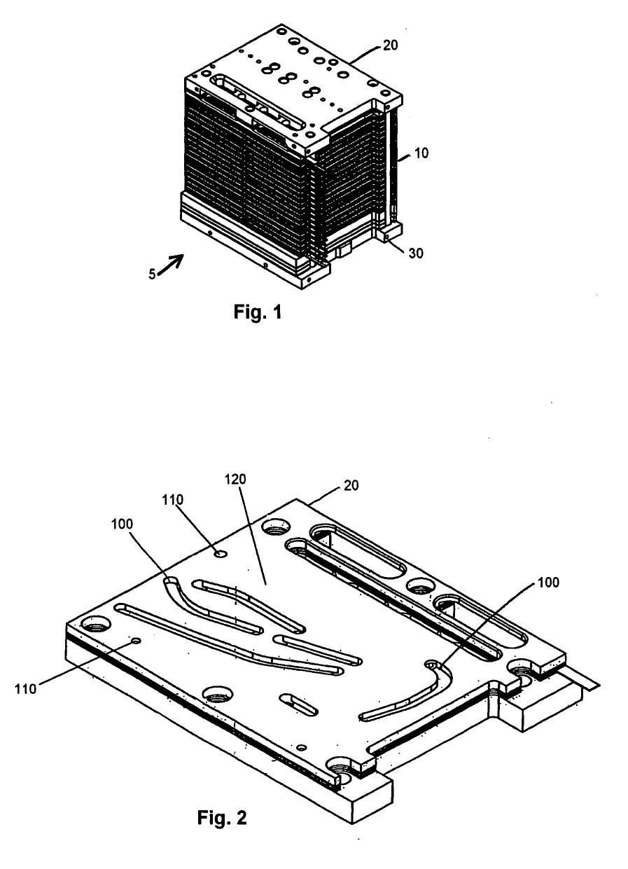

In one example, cathode endplate assembly 20 may include a plurality of fluid flow pathways which may include interior passages 100 and ports 110 as depicted in FIG.2, which is a perspective view of a stack side 120 of cathode endplate assembly 20. Ports 110 may be aligned with, and coupled to, interior conduits of fuel cell 10 to allow fluid communication between cathode endplate assembly 20 and fuel cell stack 10.

Also, an endplate assembly (e.g. cathode endplate assembly 20) may be formed of several layers stacked on top of each other and attached to one another. Passages 100 may be bounded and/or formed by one or more of the layers (e.g., a gasket layer) of such an endplate assembly (e.g. cathode endplate assembly 20) or a fuel cell stack (e.g., fuel cell stack 10).

Ports 110 may be attached to, or aligned with, any number of external fuel cell components attachable to an exterior side 130 of endplate assembly 20 referring to FIGS. 1-3, for example. In this manner, flow is directed from fuel cell stack 10 through endplate assembly 20 into such a component. Flow may also be returned from such component through a different port of endplate assembly 20 and such flow may return to fuel cell stack 10. Further, passages 100 may allow flow between ports 110 and fuel cell stack, between ports 110 and discrete fuel cell components within fuel cell system 5, or between conduits or manifolds of fuel cell stack 10 and ports 110 or such components, for example.

Passages as referred to herein indicate conduits, fluid flow paths, grooves, or channels in endplate assemblies which preferably connect ports 110 to each other, connect fuel cell components to ports 110, and/or connect conduits or manifolds of fuel cell stack 10 to such components or ports 110. Such passages are oriented generally perpendicular to a longitudinal direction of a fuel cell assembly and transverse to a direction faced by an endplate. For example, passages may be grooves or indentations in a side (e.g. an interior side) of a layer of an endplate assembly. Ports as referred to herein indicate apertures, conduits, fluid flow paths, channels or openings preferably through which a fluid enters or exits an endplate. The direct attachment or connection of an external fuel cell component to a fuel cell system (e.g., fuel cell system 5) or a port (e.g., ports 110), as described herein, refers to the components being attached (e.g., plugged in) to a port in the end plate assembly without a need for clamping to external fluid supply conduits, hoses etc. and without the external components being separated from the fuel cell system by such a conduit or hose. A “stack side” and a “stack direction” are intended to refer herein to a side closest to a fuel cell stack and a direction toward a fuel cell stack, respectively.

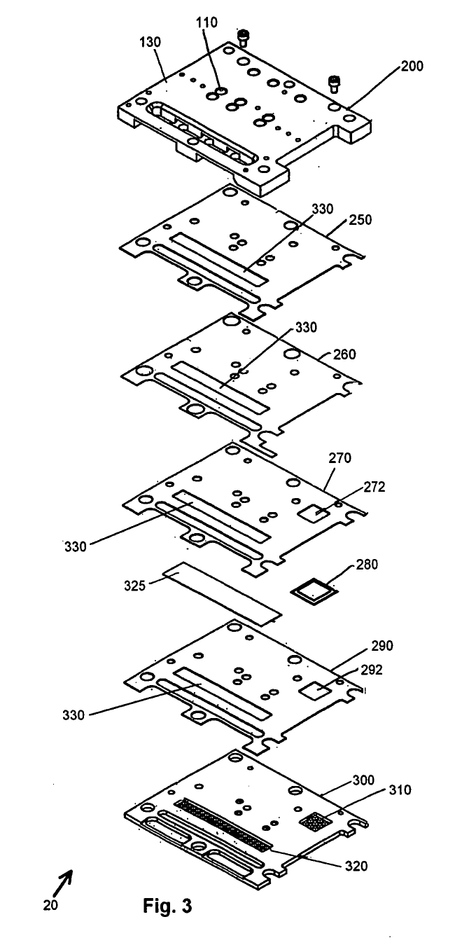

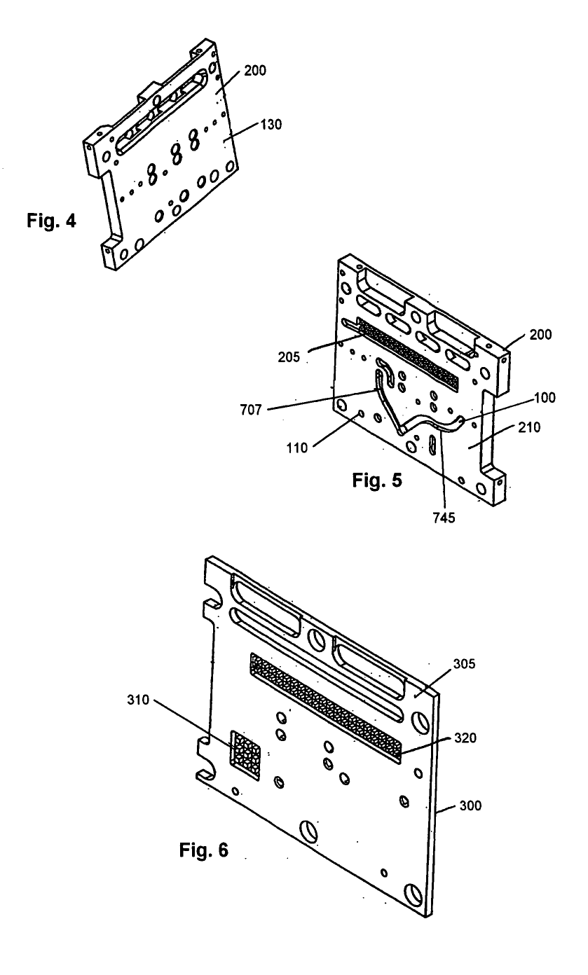

Cathode endplate assembly 20 includes a plurality of layers assembled together as best depicted in FIG. 3. In particular, an outer layer 200 includes exterior side 130 to which the components described above may be attached and an outer layer stack side 210 as best depicted in FIGS. 4-5. Outer layer stack side 210 includes passages 100 and ports 110 as described above. Outer layer stack side 210 may also include a fuel filter cavity 205.

As depicted in FIG. 3, outer layer 200 may be disposed adjacent a gasket 250 which may be disposed adjacent a current collector 260: A second gasket 270 may be mounted between current collector 260 and a concentration sensor 280. A third gasket 290 may be located between concentration sensor 280 and an inner layer 300. Thus, concentration sensor 280 is located within end plate assembly 20 and may be electrically connected to current collector 260 and at least a portion of inner layer 300. In one example, concentration sensor 280 may be a fuel cell which may measure the concentration of fuel in a particular flow path by measuring an output of the sensor 280.

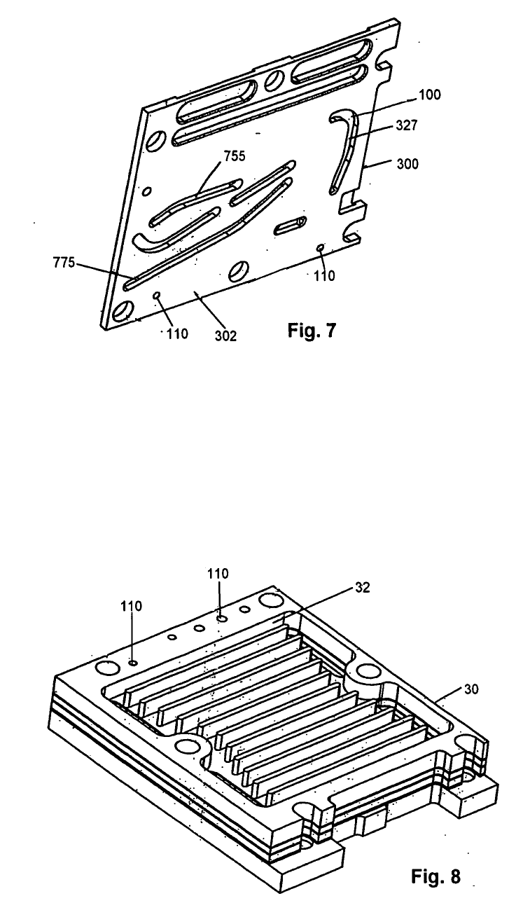

As best depicted in FIGS. 6-7, a stack side 302 of inner layer 300, corresponding to stack side 120 of assembly 20, may include passages 100 and ports 110 as described above. Further, an outer side 305 of inner layer 300 may include a concentration sensor cavity 310 for receiving concentration sensor 280. Also, as shown in FIG. 3, gasket 270 and gasket 290 may include apertures 272 and 292 respectively to allow concentration sensor 280 to contact current collector 260 and at least a portion of inner layer 300 thereby providing an electrical connection therebetween. Moreover, inner layer 300 may include a fuel filter cavity 320. A fuel filter 325 (FIG. 3) may be received in fuel filter cavity 205 and fuel filter cavity 320. The gaskets (e.g., gasket 250, gasket 270 and gasket 290) include openings 330 aligned to allow fluid to pass from fuel filter cavity 205 through filter 325 into fuel filter cavity 320.

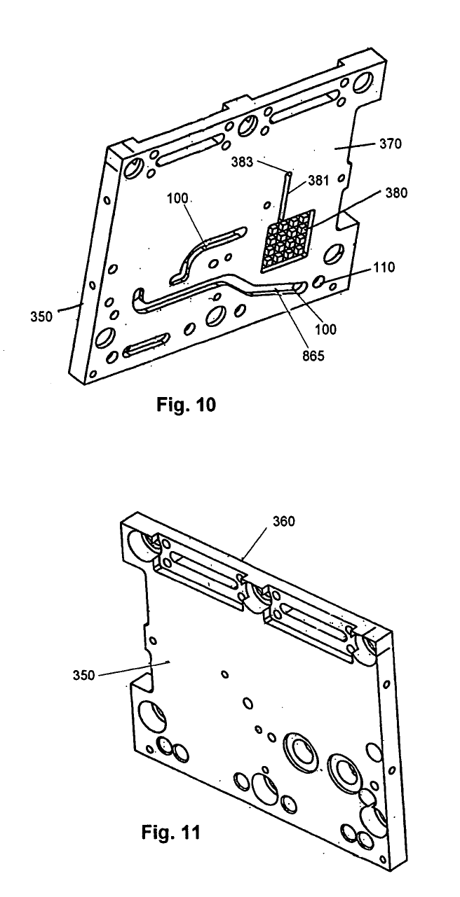

FIG. 8 depicts a perspective view of anode endplate assembly 30 which may include a plurality of interior passages 100 (see e.g., FIG. 10) and ports 110 similar to those described above for cathode endplate assembly 20. Ports 110 may be aligned with, and coupled to, interior conduits of fuel cell stack 10 to allow fluid communication between such passages and the conduits or ports as described above for cathode endplate assembly 20.

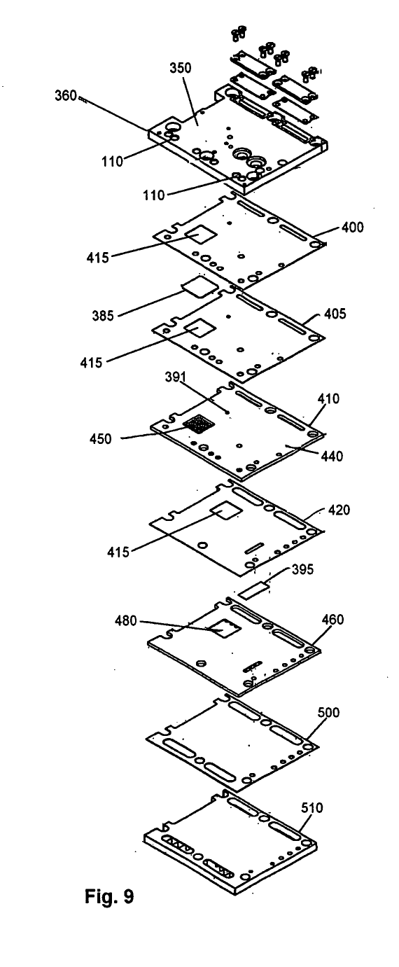

Also, ports 110 may be attached to, or aligned with, any number of external components attachable to an exterior side 350 (FIG. 9) of anode endplate assembly 30. In this manner and referring to FIGS. 1 and 11, flow may be directed from fuel cell stack 10 through endplate 30 into such a component. Flow may also be returned from such component through a different port of endplate 30 and may return to fuel cell stack 10 via one of passages 100, ports 110 and/or conduits. As described above for cathode endplate assembly 20, components may be directly attached to ports 110 and/or exterior side 350 thereby minimizing or eliminating external conduits or tubes from endplate 30 to any such components. Alternatively, such components may be integral to, or within, endplate 30. Further, such external fuel cell components may include components for supplying fluids to the fuel cell system and/or components for sensing, measuring and/or processing fluid for the fuel cell system. Such internal or external components may include valves, pumps, heat exchangers, sources of fuel, sources of water, sources of air, pressure sensors, concentration sensors, temperature sensors, filters, and gas and liquid separators, for example.

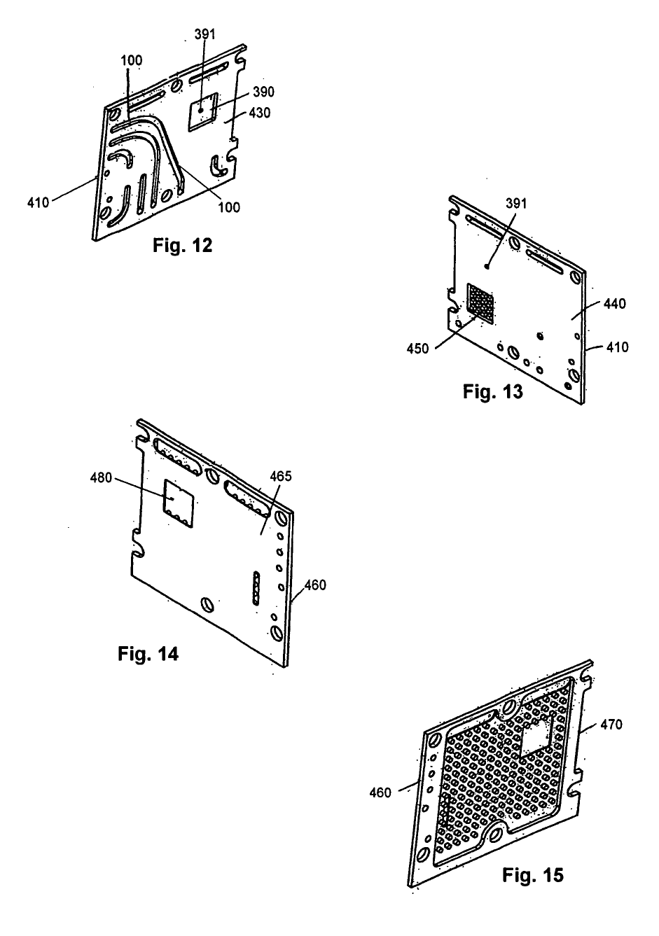

Anode endplate assembly 30 includes a plurality of layers assembled together as best depicted in FIG. 9. In particular, an outer layer 360 includes exterior side 350 attachable to the external fuel cell components described above and an outer layer stack side 370, as best depicted in FIGS. 10-11. Outer layer stack side 370 includes passages 100 and ports 110 as described above. Further, outer layer stack side 370 includes a fluid collection point 383. A fluid collection passage 381 routes fluid from fluid collection point 383 to fluid filter cavity 380. Fluid filter cavity 380 is formed by a gasket 400 and a gasket 405 which are adjacent outer layer stack side 370. A second anode endplate layer 410 may be adjacent to gasket 405, and may include a stack side 430 and an outer side 440 as best depicted in FIGS. 9 and 12-13. Outer side 440 may include a fluid filter cavity 450 configured (e.g., located on outer side 440) to be aligned with fluid filter cavity 380 to form a single fluid filter cavity when outer layer 360, second anode endplate layer 410, and gaskets 400 and 405 are mated or otherwise in contact with each other. Thus, such a single fluid filter cavity is located, and receives a filter 385, between outer layer stack side 370 of outer layer 360 and outer side 440 of second anode endplate layer 410. Fluid filter 385 functions to filter effluent drawn through fluid collection passage 381.

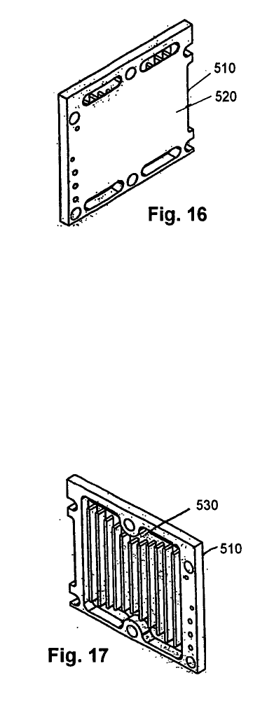

A gasket 420 is disposed between second anode endplate layer 410 and third anode endplate layer 460 as depicted in FIG. 9. FIGS. 14-15 depict an outer side 465 and a stack side 470 of third anode endplate layer 460. Third anode endplate layer 460 includes a fluid collection material opening 480. Also, a gasket 500 is received between an inner layer 510 (FIGS. 9 and 16-17) and third anode endplate layer 460. A fluid collection material 395 (FIG. 21, not shown in FIG. 9) is disposed between fluid collection cavity 390, fluid collection opening 415 of gasket 420, and fluid collection opening 480 as depicted in FIG. 9. Fluid collection material 395 (FIG. 21) is located between second anode endplate layer 410 and gasket 500. Fluid collection cavity 390 includes a fluid collection cavity opening 391 which draws fluid through second anode endplate layer 410 and allows fluid communication between fluid collection cavity 390 and fluid collection passage 381. FIGS. 16-17 depict outer side 520 and a stack side 530 (corresponding to a stack side 32 of anode endplate assembly 30) of inner layer 510).

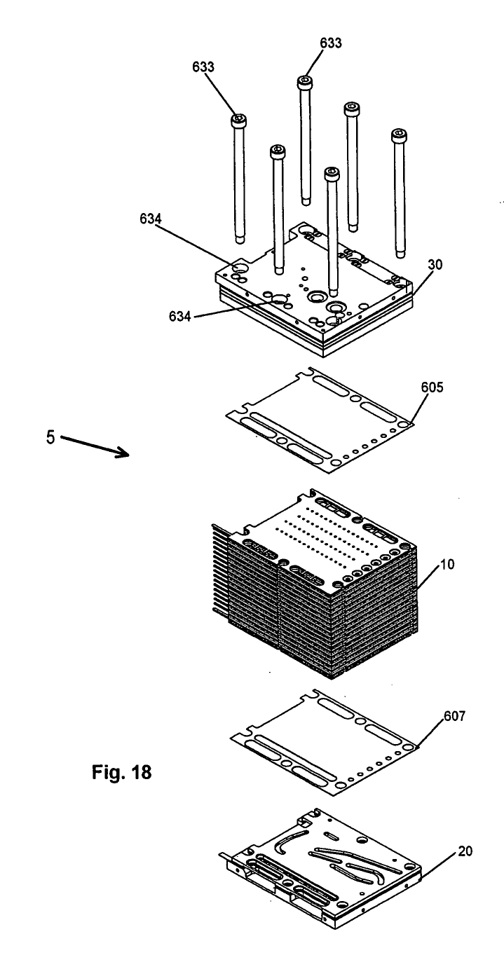

FIG. 18 depicts an exploded view of fuel cell system 5 showing anode endplate assembly 30 and cathode endplate assembly 20 being mounted to fuel cell stack 10 by bolts 633 connected through bolt holes 634. Bolts 633 may, but need not, connect to both anode plate assembly 30 and cathode plate assembly 20, and may provide compression on the fuel cell stack. A first assembly gasket 605 is disposed between anode endplate assembly 30 and fuel cell stack 10, and preferably may provide a sealing function therebetween. Also, cathode endplate assembly 20 may be mounted to fuel cell stack 10 with a second assembly gasket 607 disposed therebetween to preferably provide a sealing function. This direct connection of the endplate assemblies to fuel cell stack 10 such that the endplate assemblies are in contact with fuel cell stack 10 may minimize or eliminate a need for hoses, conduits, or other external fluid connectors between the end plate assemblies and fuel cell stack 10.

Those skilled in the art will recognize that the system and endplates set forth herein can be used with a planar fuel cell array, or a single fuel cell as known to those skilled in the art. Furthermore, the invention set forth herein can be implemented with any fuel cell system, including reformer-based systems, as well as systems that use silicon components as a means of directing the flow of electrons.

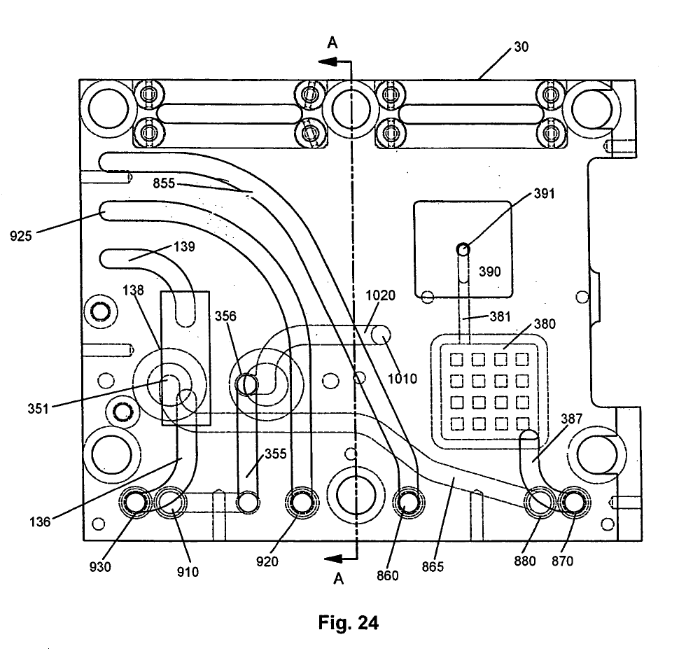

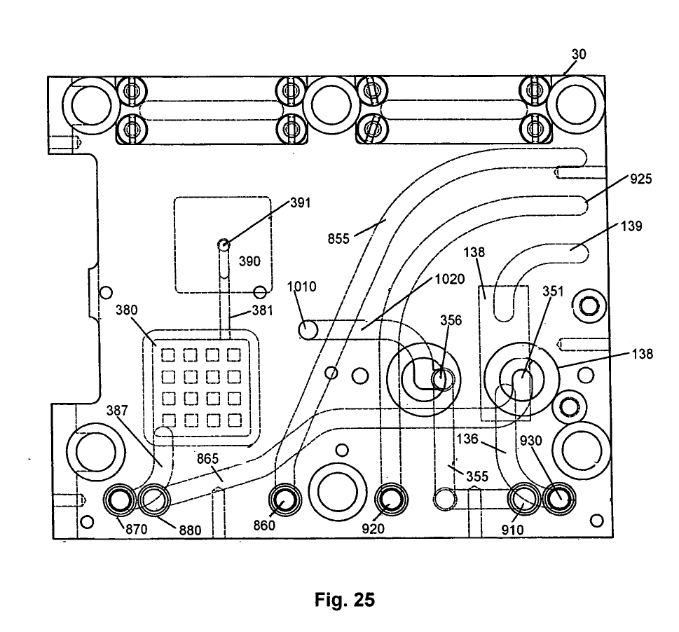

Hereinafter, a description of fluid flow through specific endplate assemblies is provided during certain modes of operation which refers to FIGS. 21-25. The fuel cell and its endplate system depicted and described includes the anode endplate assembly of FIGS. 8-17 and the cathode endplate assembly of FIGS. 2-7. These endplate assemblies are used with fuel cell assembly 5 of FIG. 1 which includes, when fully assembled, the components depicted in the schematic of FIG. 21. FIG. 21 also depicts the fluid flow paths (e.g., passage 100, ports 110, and conduits) between such components and these fluid flow paths correspond to the paths within the aforementioned cathode and anode endplate assemblies. Accordingly, the fluid flow paths, ports, and other elements indicated on FIGS. 3-17 and FIGS. 22-25 correspond to those indicated on FIG. 21.

As depicted in the schematic of fuel cell system 5 of FIG. 21, fuel cell stack 10 preferably includes a bipolar fuel cell plate with integrated gas separation, including but not limited to that set forth in commonly owned U.S. patent application Ser. No. 10/384,095, by DeFilippis, for a Bipolar Plate or Assembly having Integrated Gas-Permeable Membrane, which is incorporated herein by reference. Fuel is delivered to fuel cell stack 10, in accordance with the present invention by pump 352 that is coupled to a valve sub-system, which, in the embodiment of FIG. 21, includes five valves (i.e., a first valve 720, a second valve 760, a third valve 850, a fourth valve 900, and a fifth valve 950). The valves are controlled by a processor (not shown) that is adapted to process information regarding system operation and issue commands signaling the settings for the valves, depending upon the current mode of operation of the system. The valves depicted and described above relative to FIGS. 21-25 relate to particular modes of operation of fuel cell system 5 and the valves are depicted and described as being set in particular positions to allow fluid to flow through the valves to particular end plate assembly valve ports which are in fluid communication with particular passages, components, and conduits. The valves may also be set in various other ways to allow fluid flow to different ports, through different passages, through different conduits and to different components to allow different functions or modes of fuel cell system 5. Other such functions and modes of operation are described in co-owned U.S. application Ser. No. ______, filed May 11, 2004 and entitled “Single Pump Fuel Cell System.”

The fuel supply for fuel cell system 5 is contained in a low concentration reservoir 710 and a high concentration reservoir 712 which may be connectable to cathode endplate 20. For example, high concentration reservoir 712 may be connected to a high concentration reservoir port 715. Also, low concentration reservoir 710 may be connected to low concentration reservoir port 717.

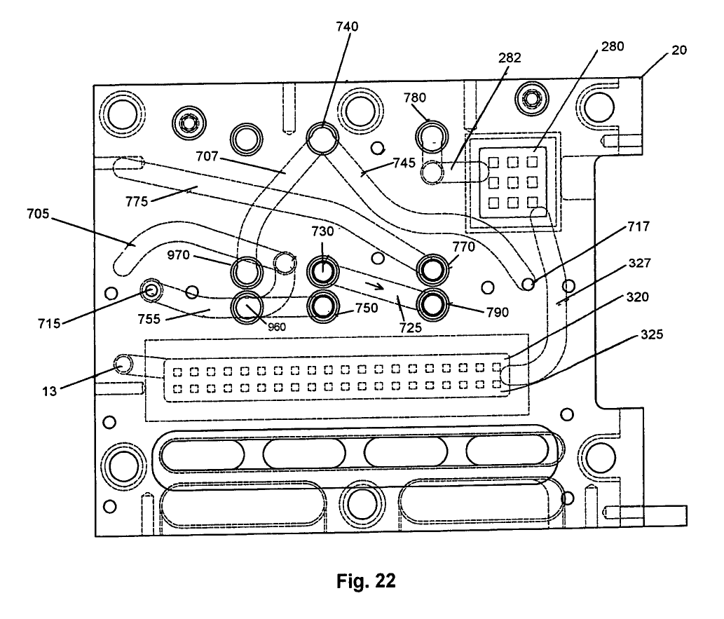

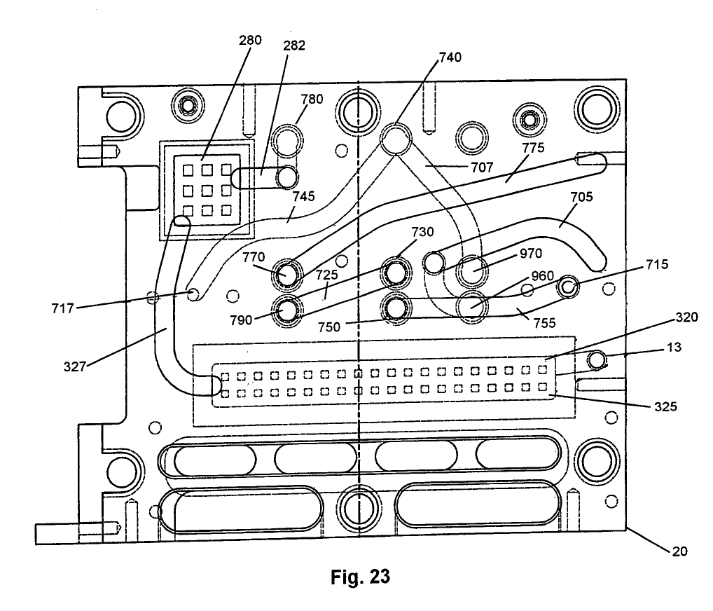

First valve 720 may connect to a first valve port (1 VP) 730, a second valve port (2 VP) 740 and a third valve port (3 VP) 750 of cathode endplate assembly 20 which are depicted in FIGS. 22-23. Also, first valve 720 is configured to switch between the low concentration fuel in reservoir 710 and high concentration fuel in reservoir 712. In particular, low concentration reservoir 710 is in fluid communication with second valve port 740 via a low concentration reservoir passage 745, and low concentration reservoir port 717, as depicted in FIGS. 5, and 21-23. Also, high concentration reservoir 712 is in fluid communication with third valve port 750 via a high concentration reservoir passage 755 and high concentration reservoir port 715, as depicted in FIGS. 7 and 21-23. First valve 720 may receive fluid from second valve port 740 and/or third valve port 750 and first valve 720 may direct fluid to first valve port 730.

Second valve 760 may be connected to a fourth valve port (4 VP) 770, a fifth valve port (5 VP) 780, and a sixth valve port (6 VP) 790. Second valve 760 is configured to switch between either dosing fuel from the reservoirs via a first valve passage 725 and first valve 720, or recirculating unreacted fuel from an anode recirculation loop 800 via fifth valve port 780 and a concentration sensor passage 282. The term “anode recirculation loop”, as used herein, shall mean those components that deliver and direct recirculated fuel to stack 10 and remove unreacted fuel from stack 10. It may also be necessary to dose fresh fuel (from reservoirs 710 and/or 712) into the anode recirculation loop. In FIG. 21, second valve 760, third valve 850, fourth valve 900, pump 352, stack 10, fuel filter 325, concentration sensor 280 and concentration sensor passage 282 and the conduits (e.g., through stack 10) and any other passages 100 connecting these components comprise the anode recirculation loop 800.

More particularly, anode recirculation loop 800 receives unreacted fuel from the anode portions of the cells in fuel cell stack 10. The unreacted fuel exits the stack 10 via a first stack conduit 13 and may then be passed through fuel filter 325 in fuel filter cavity 320. Filter 325 removes any particulates or debris that may have been picked up in the stack or through the conduits of the system. The filtered fuel is then sent via a fuel filter passage 327 to concentration sensor 280. Sensor 280 can be a separate fuel cell operable to act as a concentration sensor, as noted above. A number of different elements can be employed for the concentration sensor, or alternatively, fuel cell operating characteristics can be measured and concentration can be determined from those measurements. The sensor can measure concentration, and this information can then be used to determine whether the valves are to be set such that a low dose, or a high dose, or a recirculated fuel should be delivered to the fuel cell system. In other instances, the system can run without a concentration sensor, if desired, in a particular application of the invention. Those skilled in the art will recognize that fuel filter 325 and concentration sensor 280 may be disposed anywhere in the recirculation loop depending on the desired form factor or operating characteristics of the fuel cell system.

After passing through concentration sensor 280, the fuel continues to concentration sensor passage 282 and thus to fifth valve port 780 and second valve 760 as depicted in FIGS. 21-23. As noted herein, second valve 760 is set to deliver unreacted fuel from recirculation loop 800 via fifth valve port 780 and fourth valve port 770. Alternatively, second valve 760 may be set to deliver fuel from sixth valve port 790 to fourth valve port 770 for fresh dosing from first valve 720, as described above.

The output of second valve 760 enters second valve passage 775 via fourth valve port 770 and second valve passage 775 conducts the fluid transversely relative to a longitudinal direction of the fuel cell stack and transverse relative to a direction faced by anode endplate assembly 30 and cathode endplate assembly 20. Second valve passage 775 may be connected to a conduit 776 to allow fluid flow through stack 10 to anode plate assembly 30 where conduit 776 connects with third valve passage 855 as depicted in FIGS. 21 and 24-25. Third valve 850 is connected to anode plate assembly 30 at a seventh valve port (7 VP) 860, an eighth valve port (8 VP) 870, and a ninth valve port (9 VP) 880. Third valve passage 855 connects to third valve 850 via seventh valve port 860 to allow flow from second valve passage 775 to conduit 776 to third valve passage 855 to third valve 850. Third valve 850 can be positioned to allow fuel delivery from second valve 760 via 7 VP 860, or condensate collection via 8 VP 870.

Condensate is the fluid that condenses within the cathode aspect of the fuel cell, and is typically comprised of water, with a small amount of methanol and other substances also being present in said condensate. More specifically, condensate collection is performed when condensate from the fuel cell stack 10 is fed via a conduit, pathway, passage and/or port to a fluid collection material (e.g., fluid collection material 395) held in fluid collection cavity 390. The fluid material may preferably consist of foams, felts, sponges, woven or nonwoven cloth or sintered metals, though other materials are also within the scope of the invention. The conduit and the fluid collection material preferably permit condensate collection in any orientation of the fuel cell. The collected condensate is then sent via fluid collection cavity opening 391 and fluid collection passage 381 to fluid filter 385 held in fluid filter cavity 380, which remove particulates from the fluid. After passing through fluid filter 385, the fluid passes through fluid filter cavity 450 and passage 387 to eighth valve port 870 to third valve 850. If condensate collection is desired, third valve 850 is set to receive condensate via eighth valve port 870 and allows condensate to flow through ninth valve port 880 to pump 352 via pump passage 865.

Pump 352 is connected to anode plate assembly 30 via a first pump port 351 and a second pump port 356. Fourth valve 900 is connected to anode endplate assembly via a tenth valve port (10 VP) 910, an eleventh valve port (11 VP) 920, and a twelfth valve port (12 VP) 930. Fifth valve 950 may be connected to cathode endplate assembly 20 at a thirteenth valve port (13 VP) 960 and a fourteenth valve port (14 VP) 970. Flow is from pump 352 to tenth valve port 910 and fourth valve 900 via pump exit passage 355. If condensate collection is desired, the condensate is delivered to fourth valve 900 through tenth valve port 910 and through twelfth valve port 930 through a gas/liquid separator conduit 136 to a gas/liquid separator 138. The fluid passes through a gas/liquid separator passage 139 to a conduit 141 through fuel cell stack 10 to cathode endplate assembly 20. Then the fluid travels through fifth valve passage 705 to 13 VP 960 to fifth valve 950 to 14 VP 970 to a fifth valve passage 707 which is connected to low concentration reservoir passage 745. The condensate is then delivered into the low concentration reservoir 710 via fifth valve passage 707, low concentration reservoir passage 745 and low concentration reservoir port 717. In this way, condensate from the stack is retrieved and collected in low concentration reservoir 710 for later use through low concentration reservoir port 717.

Gas/liquid separator 138 may be desirable because pump 352 may draw a substantial amount of gas when drawing condensate out of collection material 395. This additional gas effluent is preferably eliminated prior to entry into the low concentration reservoir 710, or used to perform other work within the system. Otherwise, volume in the low concentration reservoir 710 that is intended for low concentration fuel is instead taken up by a gaseous effluent which is undesirable. Fifth valve 950 may stop or allow flow to fifth valve passage 707.

As will be understood by those skilled in the art, and depending on the operating conditions there may be instances in which the fuel cell stack requires the addition of water from the condensate, instead of fuel. This can be accomplished directly when fourth valve 900 is positioned in such a mode that the water from the collection material 395 is delivered to the stack 10 via eleventh valve port 920 and a stack passage 925. In such a case, third valve 850 is set such that water at eighth valve port 870 is delivered to pump 352. Fourth valve 900 is set such that eleventh valve port 920 routes the collected condensate to stack 10.

An optional pressure sensor 1000 may be attached to anode endplate assembly 30 at pressure sensor port 1010. Pressure sensor 1000 may be used to determine if the recirculation loop is full, partially full or empty, and whether or not there is appropriate pressure within the system. Pressure sensor 1000 may be in fluid communication with pump 352 via a pressure sensor passage 1020.

It will be understood to those skilled in the art that several of the internal and/or external components (e.g., fuel filter 325, concentration sensor 280, pressures sensor 1000, low concentration fuel reservoir 710, high concentration reservoir 712, the valves, collection material 395, fluid filter 385, and/or gas/liquid separator 138) of the fuel cell systems (e.g., fuel cell system 5) described herein may be removed while the fuel cell systems and portions thereof (e.g. cathode endplate assembly 20 and anode endplate assembly 30) remain in accordance with the present invention. Further, various other internal and/or external components (e.g., heat exchanger) not explicitly described could be included in the fuel cell systems described herein. Such components could be mounted to an external surface of one of the endplates, integrated with one of the endplates, or disposed within one of the endplates.

The endplates described above (e.g., cathode endplate assembly 20 and anode endplate assembly 30) may be formed of any material (e.g., metallic or nonmetallic) configured to provide compression to a fuel cell stack (e.g., fuel cell stack 10).

While the invention has been particularly shown and described with reference to preferred embodiments thereof, it will be understood by those skilled in the art that various changes in form and details can be made without departing from the spirit and scope of the invention. Furthermore, the terms and expressions that have been employed herein are used as terms of description and not of limitation. There is no intention in the use of such terms and expressions of excluding any equivalents of the features shown and described or portions thereof. It is recognized that various modifications are possible within the scope of the invention claimed.

Although preferred embodiments have been depicted and described in detail herein, it will be apparent to those skilled in the relevant art that various modifications, additions, substitutions and the like can be made without departing from the spirit of the invention and these are therefore considered to be within the scope of the invention as defined in the following claims.

1. An endplate assembly for a fuel cell system having a fuel cell stack, said assembly comprising:
an internal surface and an external surface, said internal surface configured to face toward the fuel cell stack, and said external surface being opposite said internal surface and configured to face away from the fuel cell stack; and
one or more fluid flow pathways located between said internal surface and said external surface, said one or more fluid flow pathways configured to direct fluid in multiple directions through the endplate assembly.

2. The endplate assembly of claim 1 wherein said one or more fluid flow pathways comprise a passage configured to direct fluid in a direction transverse to the direction faced by said internal surface.

3. The endplate assembly of claim 1 wherein said one or more fluid flow pathways is couplable to a conduit of the fuel cell stack to allow fluid communication between said one or more fluid flow pathways and the stack in response to the endplate assembly being engaged with the fuel cell stack.

4. The endplate assembly of claim 3 wherein said one or more fluid flow pathways is configured to receive the fluid from the conduit and said one or more fluid flow pathways is configured to direct the fluid into a second conduit of the fuel cell stack.

5. The endplate assembly of claim 1 wherein said one or more fluid flow pathways comprise a port configured to provide fluid communication between said one or more fluid flow pathways and said external surface.

6. The endplate assembly of claim 5 wherein said port is configured to be directly connected to an external component engageable with said external surface to provide fluid communication between said one or more fluid flow pathways and said external component in response to the external component being engaged with said external surface.

7. The endplate assembly of claim 6 wherein said external component comprises at least one of a fluid supply component, a fluid processing component, a sensing component, and a measuring component.

8. The endplate assembly of claim 1 further comprising at least one of a fluid processing component, a sensing component, and a measuring component located between said internal surface and said external surface.

9. The endplate assembly of claim 8 wherein said at least one of a fluid processing component, a sensing component, and a measuring component is at least partially integrated with the endplate assembly.

10. The endplate assembly of claim 8 further comprising a plurality of layers wherein said at least one of a fluid processing component, a sensing component, and a measuring component is integral to at least one layer of said plurality of layers.

11. The endplate assembly of claim 8 wherein said component is mechanically attached to the endplate assembly.

12. The endplate assembly of claim 1 comprising a plurality of layers and wherein said one or more fluid flow pathways comprises a channel in at least one layer of said plurality of layers.

13. The endplate assembly of claim 12 wherein said one or more fluid flow pathways is formed by said channel and a surface of another layer of said plurality of layers.

14. The endplate assembly of claim 1 further comprising a plurality of layers wherein a first layer of said plurality of layers comprises an internal fluid flow passage of said one or more fluid flow pathways configured to direct the fluid in a direction transverse to the direction faced by said internal surface and the direction faced by said external surface, and a second layer of said plurality of layers comprises a second internal fluid flow passage of said one or more fluid flow pathways configured to receive fluid from the fuel cell stack and to direct the fluid in a second direction transverse to the direction faced by said internal surface and the direction faced by said external surface.

15. The endplate assembly of claim 1 further comprising an interior portion located between said internal surface and said external surface, wherein said one or more fluid flow pathways comprises a port configured to provide fluid communication between said external surface and said interior portion.

16. The endplate assembly of claim 1 wherein said one or more fluid flow pathways further comprises a port configured to provide fluid communication between said one or more fluid flow pathways and said internal surface.

17. The endplate assembly of claim 15 wherein said port is configured to be directly connected to an external component engageable with said external surface to provide fluid communication between said interior portion and said external component in response to the external component being engaged with said external surface.

18. The endplate assembly of claim 17 wherein said external component comprises at least one of a fluid supply component, a fluid processing component, a sensing component, and a measuring component.

19. The endplate assembly of claim 1 wherein said one or more pathways directs a fuel.

20. The endplate assembly of claim 1 wherein said one or more pathways directs products of a reaction of the fuel cell stack.

21. The endplate assembly of claim 1 wherein the fuel cell stack is a direct oxidation fuel cell stack.

22. The endplate assembly of claim 1 wherein the fuel cell stack is a direct methanol fuel cell stack.

23. A fuel cell system, comprising:
a fuel cell stack;
an endplate assembly connected to said fuel cell stack, said endplate assembly having an external surface and an internal surface, said internal surface facing toward said fuel cell stack, and said external surface being opposite said internal surface and facing away from said fuel cell stack; and
said endplate assembly comprising one or more fluid flow pathways located between said internal surface and said external surface, said one or more fluid flow pathways configured to direct fluid in multiple directions through the endplate assembly.

24. The fuel cell system of claim 23 wherein said one or more fluid flow pathways comprise a passage configured to direct fluid in a direction transverse to the direction faced by said internal surface.

25. The fuel cell system of claim 24 wherein said fuel cell stack comprises a conduit and wherein said one or more fluid flow pathways is coupled to said conduit to allow fluid communication between said one or more fluid flow pathways and said fuel cell stack.

26. The fuel cell system of claim 25 and wherein said one or more fluid flow pathways is configured to receive the fluid from said conduit and said one or more fluid flow pathways is configured to direct the fluid into a second conduit of said fuel cell stack.

27. The fuel cell system of claim 23 wherein said one or more fluid flow pathways further comprises a port configured to provide fluid communication between said one or more fluid flow pathways and said external surface.

28. The fuel cell system of claim 27 further comprising an external component connected to said external surface wherein said port is coupled to said external component to provide fluid communication between said one or more fluid flow pathways and said external component.

29. The fuel cell system of claim 28 wherein said external component comprises at least one of at least one of a fluid supply component, a fluid processing component, a sensing component, and a measuring component.

30. The fuel cell system of claim 23 wherein said one or more fluid flow pathways further comprises a port configured to provide fluid communication between said one or more fluid flow pathways and said internal surface.

31. The fuel cell system of claim 23 wherein said endplate assembly comprises a plurality of layers and wherein said one or more fluid flow pathways comprises a channel in at least one layer of said plurality of layers.

32. The endplate assembly of claim 31 wherein said one or more fluid flow pathways is formed by said channel and a surface of another layer of said plurality of layers.

33. The fuel cell system of claim 23 wherein said endplate assembly comprises a plurality of layers wherein a first layer of said plurality of layers comprises an internal fluid flow passage of said one or more fluid flow pathways configured to direct fluid in a direction transverse to the direction faced by said internal surface and the direction faced by said external surface, and a second layer of said plurality of layers comprises a second internal fluid flow passage of said one or more fluid flow pathways configured to receive fluid from said fuel cell stack and to direct fluid in a second direction transverse to the direction faced by said internal surface and the direction faced by said external surface.

34. The fuel cell system of claim 23 wherein said endplate assembly further comprises an interior portion between said internal surface and said external surface and said one or more fluid flow pathways comprises a port configured to provide fluid communication between said external surface and said interior portion.

35. The fuel cell system of claim 34 further comprising an external component connected to said external surface, said port coupled to said external component to provide fluid communication between said internal portion and said external component.

36. The fuel cell system of claim 35 wherein said external component comprises at least one of a fluid supply component, a fluid processing component, a sensing component, and a measuring component.

37. The fuel cell system of claim 23 wherein said endplate assembly comprises at least one of a fluid processing component, a sensing component, and a measuring component located between said internal surface and said external surface.

38. The fuel cell system of claim 37 wherein said at least one of a fluid processing component, a sensing component, and a measuring component is at least partially integrated with said endplate assembly.

39. The fuel cell system of claim 37 wherein said endplate assembly comprises a plurality of layers and wherein said at least one of a fluid processing component, a sensing component, and a measuring component is integral to at least one layer of said plurality of layers.

40. The fuel cell system of claim 37 wherein said at least one of a fluid processing component, a sensing component, and a measuring component is mechanically attached to said endplate assembly.

41. The fuel cell system of claim 23 wherein said one or more pathways direct a fuel.

42. The fuel cell system of claim 23 wherein said one or more pathways directs products of a reaction of said fuel cell.

43. The fuel cell system of claim 23 wherein said fuel cell stack is a direct oxidation fuel cell stack.

44. The fuel cell system of claim 23 wherein said fuel cell stack is a direct methanol fuel cell stack.

45. An endplate assembly for a fuel cell system having a fuel cell stack, said assembly comprising:
an external surface, an internal surface and an interior portion located between said internal surface and said external surface;
said internal surface facing toward said fuel cell stack, and said external surface being opposite said internal surface and facing away from said fuel cell stack, in response to said internal surface being engaged with the fuel cell stack; and
said external surface comprising a port configured to allow an external fuel cell component to be mounted thereon to provide direct fluid communication between said interior portion and the external fuel cell component.

46. The endplate assembly of claim 45 wherein the external component comprises at least one of a fluid supply component, a fluid processing component, a sensing component, and a measuring component.

47. The endplate assembly of claim 45 further comprising one or more fluid flow pathways located between said internal surface and said external surface, said one or more fluid flow pathways configured to direct fluid in multiple directions through the endplate assembly.

48. The endplate assembly of claim 47 wherein said port is in fluid communication with said at least one internal fluid flow passage.

49. The endplate assembly of claim 45 further comprising at least one of a fluid processing component, a measuring component, and a sensing component located in said interior portion.

50. The endplate assembly of claim 49 wherein said at least one of a fluid processing component, a measuring component, and a sensing component is at least partially integrated with said interior portion.

51. The endplate assembly of claim 49 wherein said at least one of a fluid processing component, a measuring component, and a sensing component is mechanically attached to at least a portion of said interior portion.

52. The endplate assembly of claim 49 wherein said end plate assembly further comprises a plurality of layers and wherein said at least one of a fluid processing component, a measuring component, and a sensing component is integral to at least one layer of said plurality of layers.

53. The endplate assembly of claim 45 wherein said port directs a fuel.

54. The endplate assembly of claim 45 wherein said port directs products of a reaction of the fuel cell stack.

55. The endplate assembly of claim 45 wherein the fuel cell stack is a direct oxidation fuel cells stack.

56. The endplate assembly of claim 45 wherein the fuel cell stack is a direct methanol fuel cell stack.

57. A fuel cell system, comprising:
a fuel cell stack;
an endplate assembly connected to said fuel cell stack, said endplate assembly comprising an internal surface and an external surface, said internal surface facing toward said fuel cell stack, and said external surface being opposite said internal surface and facing away from said fuel cell stack; and
said external surface comprising a port configured to allow an external fuel cell component to be mounted thereon to provide direct fluid communication between said endplate assembly and the external fuel cell component.

58. The system of claim 57 further comprising an external fuel cell component connected to said port and wherein said external component comprises at least one of a fluid supply component, a fluid processing component, a sensing component and a measuring component.

59. The system of claim 57 wherein said endplate assembly further comprises one or more fluid flow pathways located between said internal surface and said external surface, said one or more fluid flow pathways configured to direct fluid in multiple directions through the endplate assembly.

60. The system of claim 59 wherein said port is in fluid communication with said one or more fluid flow pathways.

61. The system of claim 57 further comprising at least one of a fluid processing component, a measuring component, and a sensing component located within said endplate assembly.

62. The system of claim 61 wherein said at least one of a fluid processing component, a measuring component, and a sensing component is at least partially integrated with said endplate assembly.

63. The system of claim 61 wherein said at least one of a fluid processing component, a measuring component, and a sensing component is mechanically attached to said endplate assembly.

64. The system of claim 61 wherein said endplate assembly comprises a plurality of layers and wherein said at least one of a fluid processing component, a measuring component, and a sensing component is integral to at least one layer of said plurality of layers.

65. The system of claim 57 wherein said port directs a fuel.

66. The system of claim 57 wherein said port directs products of a reaction of the fuel cell stack.

67. The system of claim 57 wherein said fuel cell stack is a direct oxidation fuel cell stack.

68. The system of claim 57 wherein said fuel cell stack is a direct methanol fuel cell stack.

69. An endplate assembly for a fuel cell system having a fuel cell stack, said assembly comprising:
an internal surface and an external surface, said internal surface configured to face toward the fuel cell stack, and said external surface being opposite said internal surface and configured to face away from the fuel cell stack; and
at least one of a fluid processing component, a measuring component, and a sensing component located between said internal surface and said external surface.

70. The endplate assembly of claim 69 further comprising one or more fluid flow pathways located between said internal surface and said external surface and connected to said at least one of a fluid processing component, a measuring component, and a sensing component.

71. The endplate assembly of claim 70 wherein said one or more fluid flow pathways is configured to direct fluid in multiple directions through the endplate assembly.

72. The endplate assembly of claim 70 wherein said one or more fluid flow pathways comprise at least one port configured to provide fluid communication between said one or more fluid flow pathways and at least one of a fluid processing component, a measuring component, and a sensing component connected to said external surface.

73. The endplate assembly of claim 72 wherein said at least one port is directly connected to said at least one of a fluid processing component, a measuring component, and a sensing component connected to said external surface.

74. The endplate assembly of claim 69 further comprising a plurality of layers and wherein said at least one of a fluid processing component, a measuring component, and a sensing component is at least partially integral to at least one layer of said plurality of layers.

75. The endplate assembly of claim 69 further comprising a plurality of layers and wherein said at least one of a fluid processing component, a measuring component, and a sensing component is mechanically attached to at least one layer of said plurality of layers.

76. The endplate assembly of claim 69 wherein the fuel cell stack is a direct oxidation fuel cell stack.

77. The endplate assembly of claim 69 wherein the fuel cell stack is a direct methanol fuel cell stack.

78. A fuel cell system, comprising:
a fuel cell stack;
an endplate assembly connected to said fuel cell stack, said endplate assembly having an external surface and an internal surface, said internal surface facing toward said fuel cell stack, and said external surface being opposite said internal surface and facing away from said fuel cell stack; and
said endplate assembly comprising at least one of a fluid processing component, a measuring component, and a sensing component located between said internal surface and said external surface.

79. The fuel cell system of claim 78 wherein said endplate assembly comprises one or more fluid flow pathways located between said internal surface and said external surface and connected to said at least one of a fluid processing component, a measuring component, and a sensing component.

80. The fuel cell system of claim 79 wherein said one or more fluid flow pathways is configured to direct fluid in multiple directions through the endplate assembly.

81. The fuel cell system of claim 80 wherein said one or more fluid flow pathways further comprise at least one port configured to provide fluid communication between said one or more fluid flow pathways and at least one of a fluid processing component, a measuring component, and a sensing component connected to said external surface.

82. The fuel cell system of claim 81 wherein said at least one port is directly connected to said at least one of a fluid processing component, a measuring component, and a sensing component connected to said external surface.

83. The system of claim 78 wherein said at least one of a fluid processing component, a measuring component, and a sensing component is at least partially integrated with said endplate assembly.

84. The system of claim 83 wherein said at least one of a fluid processing component, a measuring component, and a sensing component is mechanically attached to said endplate assembly.

85. The system of claim 78 wherein said endplate assembly further comprises a plurality of layers and wherein said at least one of a fluid processing component, a measuring component, and a sensing component is integral to at least one layer of said plurality of layers.

86. The system of claim 78 wherein said fuel cell stack comprises a direct oxidation fuel cell stack.

87. The system of claim 78 wherein said fuel cell stack comprises a direct methanol fuel cell stack.
